(19) United States
(12) Patent Application Publication
(10) Pub. No.: US 2010/0322142 A1
(43) Pub. Date: Dec. 23, 2010

(54) RANGING METHOD IN MOBILE COMMUNICATION SYSTEM AND RELAY STATION FOR PERFORMING THE METHOD

(76) Inventors: Eunkyung Kim, Seoul (KR); Hyun-Jae Kim, Incheon-city (KR); Kyung-Soo Kim, Daejeon-city (KR)

Correspondence Address: STAAS & HALSEY LLP, SUITE 700, 1201 NEW YORK AVENUE, N.W., WASHINGTON, DC, 20005, US

(21) Appl. No.: 12/745,401

(22) PCT Filed: Jul. 9, 2008
(86) PCT No.: PCT/KR08/04020

§ 371 Date: May 28, 2010

(30) Foreign Application Priority Data
Nov. 30, 2007 (KR) 10-2007-0123650
Feb. 25, 2008 (KR) 10-2008-0016934

(51) Int. Cl. H04B 7/216; H04B 7/14

(52) U.S. Cl. 370/315

(57) ABSTRACT

Provided are a ranging method in a mobile communication system, and a relay station (RS) for performing the method. The RS checks whether the status of each of a plurality of ranging codes received from one or more mobile stations (MSs) corresponds to “success”, “continue”, or “abort”, and generates and transmits a message requesting at least one of a Code Division Multiple Access (CDMA) allocation information element and a bandwidth, thereby efficiently performing a ranging process.

### CROSS-REFERENCE TO RELATED PATENT APPLICATION

This application claims the benefit of Korean Patent Application No. 10-2007-0123650, filed on Nov. 30, 2007, and K.P.A No. 10-2008-0016934 filed on Feb. 25, 2008 in the Korean Intellectual Property Office, the disclosures of which are incorporated herein their entirety by reference.

### BACKGROUND OF THE INVENTION

1. Field of the Invention

The present invention relates to a mobile communication system including a base station (BS), a relay station (RS), and a mobile station (MS), and more particularly, to a method for performing ranging between a BS and an MS via an RS in a mobile communication system.

The present invention is derived from research conducted by the ‘Information Technology (IT) Research and Development Program’ of the Ministry of Information and Communications (MIC) and the Institute for Information Technology Advancement (IITA), Republic of Korea. The project management number is '2006-S-011-02, and the title is ‘Development of relay/mesh communication system for multi-hop WiBro’.

2. Description of the Related Art

Mobile communication systems include relay stations (RS) in order to cover shadow zones. With regard to the Institute of Electrical and Electronics Engineers (IEEE) 802.16 WirelessMAN standard, a standardization discussion for expansion of a system service area and improvement of system efficiency has started.

In the case where a non-transparent RS with a centralized scheduling scheme attempts to request and be allocated a source by using a bandwidth request code of a mobile station (MS), when the RS successfully receives a ranging code from the MS, the RS informs a base station (BS) of information about the received ranging code by using a multihop relay code report (MR_Code-REP) header. Also, when the RS successfully receives a Code Division Multiple Access (CDMA) code from the MS, the RS transmits a ranging response message (hereinafter, ‘an RNG-RSP’) to the MS. In order to transmit the RNG-RSP, the RS requests a resource such as a bandwidth for transmission of the RNG-RSP to the BS via an RS bandwidth request (BR) header. The BS allocates a source having a requested size to the RS via an RS_DL_MAP-IE of a downlink map (DL-MAP). If the RS does not receive a periodic ranging code for successful ranging, the MS adjusts a time and a power so as to successfully transmit a ranging code, and performs periodic ranging again.

FIG. 1 is a flowchart of a conventional process in which an MS 100 requests and is allocated a resource from a BS 120 via an RS 110.

Referring to FIG. 1, the BS 120 periodically and downward transmits an UL-MAP (S130, S165, and S185). In order to request the resource, the MS 100 transmits a bandwidth request code (BW Req Code) to the RS 110 (S135). The RS 110 relays the received BW Req Code to the BS 120 (S140). When the RS 110 successfully receives the BW Req Code from the MS 100, the RS 110 transmits information about the BW Req Code, received from the MS 100, to the BS 120 by using an MR_Code-REP (S150). Then, the BS 120 transmits a CDMA Alloc IE to the MS 100 via the UL-MAP (S155). In order to be allocated the resource via the received CDMA Alloc IE, the MS 100 transmits a bandwidth request generic MAC header (BW Req GMH) to the RS 110 (S160). The RS 110 relays the received BW Req GMH to the BS 120 (S170), and is allocated the resource from the BS 120 (S175). The MS 100 transmits data to the RS 110 via the received resource (S180), and the RS 110 forwards the received data to the BS 120 (S190).

FIG. 2 is a flowchart of another conventional process in which an MS 200 performs ranging with a BS 220 via an RS 210.

Referring to FIG. 2, the BS 220 periodically transmits an RS uplink map (RS UL-MAP) including a ranging information element (RNG IE) having an RS basic connection identification (CID) (S230), and the RS 210 relays an UL-MAP having a broadcast CID to the MS 200 (S232). The MS 200 randomly selects a CDMA ranging code in a given ranging zone, and transmits the selected CDMA ranging code to the RS 210 (S234). If a status of the received ranging code remains in “continue” (S235), the RS 210 transmits an RS BR Header for a bandwidth request to the BS 220 (S236), and is allocated a down resource including a downlink bandwidth for transmission of an RNG-RSP from the BS 220 (S238). The RS 210 transmits an RNG-RSP including adjustment information, a status, and the like to the MS 200 by using the allocated down resource (S242). The MS 200 adjusts a time parameter and a power parameter by using the received RNG-RSP (S244), and transmits again a CDMA ranging code (S250). The RS 210 requests a resource for transmission of an RNG-RSP to the BS 220 so as to inform the MS 200 that ranging has been successfully performed (S252), is allocated the resource (S254), and transmits an RNS-RSP in a “success” status to the MS 200 (S256, and S258). As described above, in conventional ranging, the resource allocation has to be continuously requested via the RS BR Header such that redundancy occurs.

### SUMMARY OF THE INVENTION

The present invention provides an improved ranging method, whereby a resource and information of a ranging code received from centralized scheduling of a base station (BS) supporting a non-transparent relay station (RS) in a broadband wireless connection system are requested simultaneously, and an RS for the ranging method.

According to an aspect of the present invention, there is provided a ranging method of an RS in a mobile communication system comprising a BS, the RS, and one or more mobile stations (MSs), the ranging method including the operations of: checking a status of each of a plurality of ranging codes received from the one or more MSs; generating a message for a request of a Code Division Multiple Access (CDMA) allocation information element together with a bandwidth when the status of some of the ranging codes is one of “continue” and “abort”; and transmitting the generated message to the BS.

According to another aspect of the present invention, there is provided an RS performing ranging, the RS including: a ranging code check unit checking a status of each of a plurality of ranging codes received from one or more MSs; a message generation unit generating a message for a request of a CDMA allocation information element together with a bandwidth when the status of some of the ranging codes is one of “continue” and “abort”; and a message transmitting unit transmitting the generated message to a BS.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart of a conventional process in which a mobile station (MS) requests and is allocated a resource from a base station (BS) via a relay station (RS);

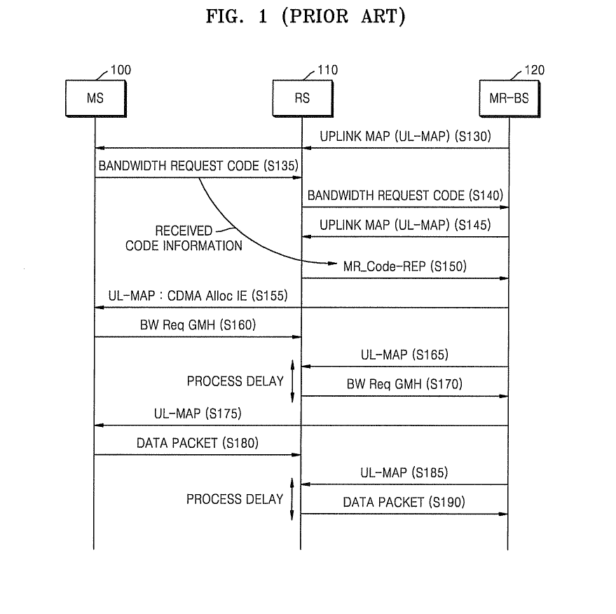

FIG. 2 is a flowchart of another conventional process in which an MS performs ranging with a BS via an RS;

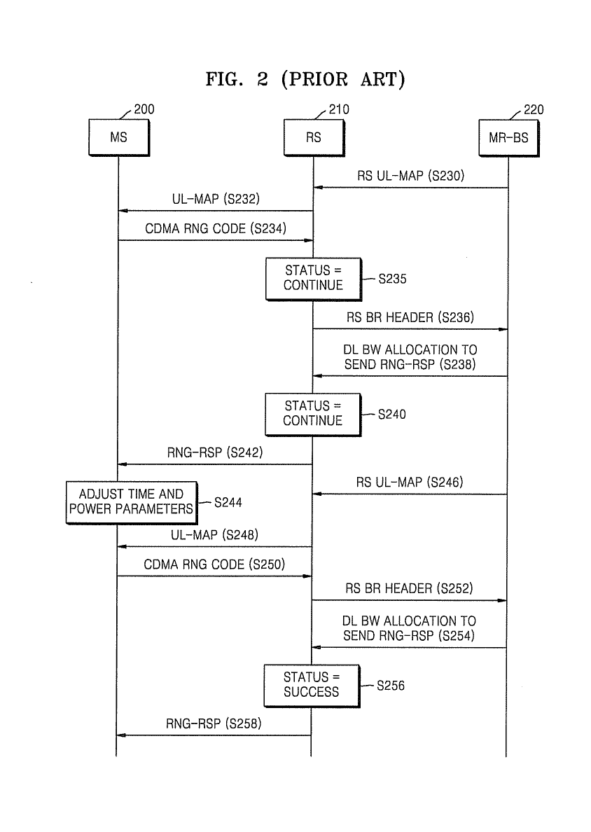

FIG. 3 is a block diagram illustrating a structure of an RS according to an embodiment of the present invention;

FIG. 4 is a flowchart of a ranging method in an RS, according to an embodiment of the present invention;

FIG. 5A is a diagram illustrating an example of a conventional message format for a request of Code Division Multiple Access (CDMA) allocation element information; and

FIG. 5B is a diagram illustrating an example of a message format for a request of CDMA allocation element information, according to an embodiment of the present invention.

### DETAILED DESCRIPTION OF THE INVENTION

The present invention will now be described more fully with reference to the accompanying drawings, in which exemplary embodiments of the invention are shown.

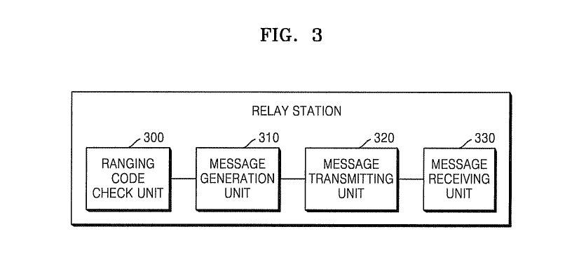

FIG. 3 is a block diagram illustrating a structure of a relay station (RS) according to an embodiment of the present invention.

Referring to FIG. 3, the RS according to the current embodiment of the present invention includes a ranging code check unit 300, a message generation unit 310, a message transmitting unit 320, and a message receiving unit 330.

The ranging code check unit 300 checks whether the status of each of a plurality of ranging codes received from one or more mobile stations (MSs) corresponds to “success”, “continue”, or “abort”.

The message generation unit 310 generates a Code Division Multiple Access (CDMA) allocation information element (hereinafter, ‘a CDMA Alloc IE) request message, a bandwidth and CDMA Alloc IE request message, or a bandwidth request message, according to the status of each of the received ranging codes. Here, since the CDMA Alloc IE is defined in the Institute of Electrical and Electronics Engineers (IEEE) 802.16 WirelessMAN standard, a detailed description thereof is not provided here.

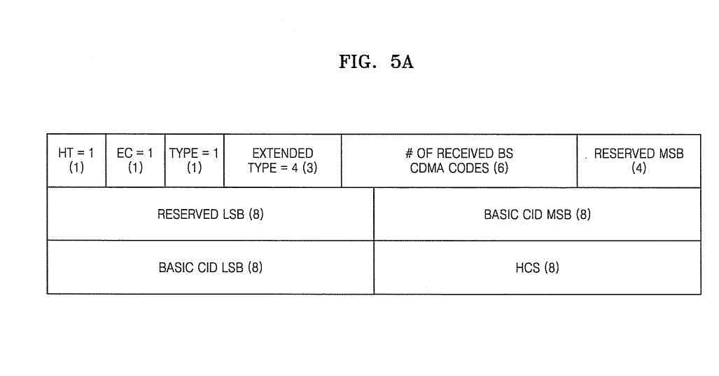

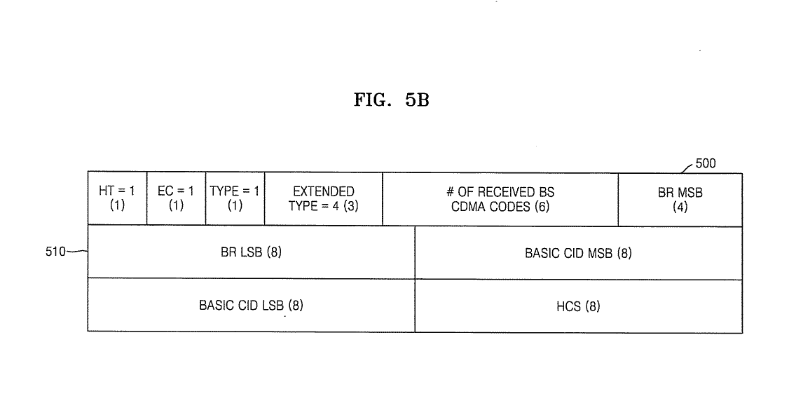

To be more specific, first, if the status of all of the ranging codes is “success”, the message generation unit 310 generates the CDMA Alloc IE request message. The CDMA Alloc IE request message may include information about the ranging codes received by the RS from the one or more MSs. An example of the CDMA Alloc IE request message is a multihop relay code report (MR_Code-REP) header illustrated in FIG. 5A. Next, if the status of some of the ranging codes is “continue” or “abort”, the message generation unit 310 generates the bandwidth and CDMA Alloc IE request message. An example of such a bandwidth and CDMA Alloc IE request message is illustrated in FIG. 5B, which is obtained by adding bandwidth request information to a reserved most significant bit (MSB)/least significant bit (LSB) field of the MR_Code-REP header illustrated in FIG. 5A. Last, if the status of all of the ranging codes is “continue” or “abort”, the message generation unit 310 generates the bandwidth request message. An example of the bandwidth request message may be an RS Bandwidth Request (BR) header defined in the IEEE 802.16. The RS BR header is a message for requesting a bandwidth for an access link for transmission of a message formed in the RS. Since the RS BR header is defined in the IEEE 802.16, a detailed description thereof is not provided here. The message generation unit 310 transmits the generated message to a base station (BS).

The message receiving unit 330 receives a message including resource allocation information such as the CDMA Alloc IE and/or the bandwidth, according to the request included in the message generated by the message generation unit 310 and transmitted to the BS. The message receiving unit 330 may receive the CDMA Alloc IE via an uplink map (UL-MAP).

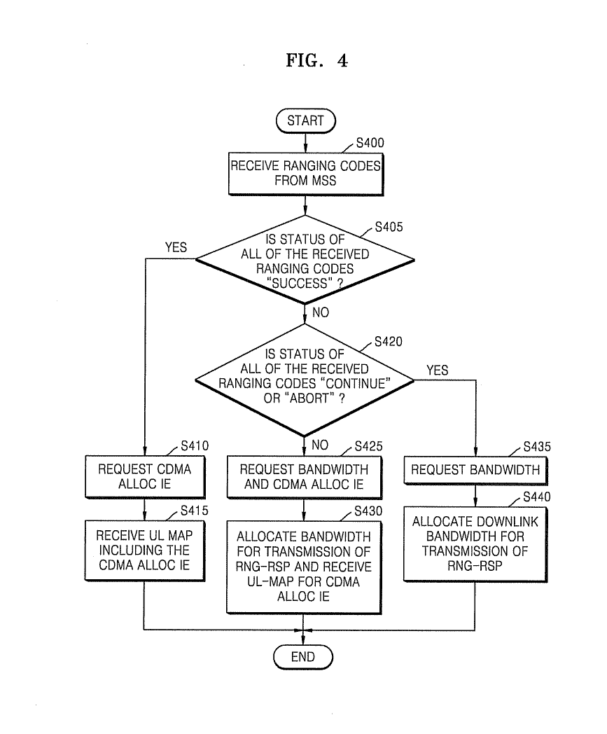

FIG. 4 is a flowchart of a ranging method in an RS, according to an embodiment of the present invention.

Referring to FIG. 4, when the RS receives a plurality of ranging codes from one or more MSs (S400), the RS checks a status of each of the received ranging codes.

First, if the status of all of the received ranging codes is “success” (S405), the RS transmits a CDMA Alloc IE request message to a BS (S410). An example of the CDMA Alloc IE request message may be the MR_Code-REP header of the IEEE 802.16 illustrated in FIG. 5A, or the message illustrated in FIG. 5B. When the BS receives the CDMA Alloc IE request message, the BS transmits a CDMA Alloc IE to the RS (S415). At this time, the BS may include the CDMA Alloc IE in an uplink map (UL-MAP), and transmit the UL-MAP to the RS.

If the status of some of the received ranging codes is not “success” but “continue” or “abort” (S405 and S420), the RS transmits a bandwidth and CDMA Alloc IE request message to the BS (S425). The RS according to the present invention does not separately transmit a bandwidth request message and a CDMA Alloc IE request message to the BS, but integrates the bandwidth request message and the CDMA Alloc IE request message into one request message and transmits the one request message to the BS. An example of the one request message may be the message illustrated in FIG. 5B, which is obtained by adding bandwidth request information to a reserved MSB and LSB field of the MR_Code-REP header illustrated in FIG. 5A. The BS receives the bandwidth and CDMA Alloc IE request message, allocates a resource for a ranging response message (hereinafter, ‘an RNG-RSP’) to the RS, and transmits the CDMA Alloc IE to the RS (S430). The CDMA Alloc IE may be transmitted to the RS via the UL-MAP.

If the status of all of the received ranging codes is “continue” or “abort”, the RS transmits a bandwidth request message to the BS (S435). An example of the bandwidth request message may be the RS BR header defined in the IEEE 802.16. The BS receives the bandwidth request message, and allocates a downlink bandwidth for transmission of the RNG-RSP to the RS (S440). The RS is allocated a resource, and performs ranging again.

FIG. 5A is a diagram illustrating an example of a conventional message format for a request of CDMA allocation element information. FIG. 5B is a diagram illustrating an example of a message format for a request of CDMA allocation element information, according to an embodiment of the present invention.

Referring to FIG. 5A, the conventional message format for the request of the conventional CDMA allocation element information is an MR_Code-REP header defined in IEEE 802.16j. The MR_Code-REP header includes a header type (HT) field, an encryption control (EC) field, a type field, an extended type field, the number of received BS CDMA codes, a reserved MSB field, a reserved LSB field, a basic connection identification (CID) MSB field, a basic CID LSB field, and a header check sequence (HCS) field.

Referring to FIG. 5B, the message format according to an embodiment of the present invention is the same as the conventional message format of 5A, except that the reserved MSB field and the reserved LSB field in FIG. 5A are respectively used as bandwidth request fields 500 and 510. Thus, unlike conventional transmission of two messages, that is, the MR_Code-REP header and the RS BR header, ranging may be performed by transmitting only once a message having the message format illustrated in FIG. 5B.

According to the present invention, in the case where the RS receives ranging codes from more than two MSs, an overhead caused by simultaneously transmitting the MR_Code-REP header and the RS BR header to the BS can be reduced. In particular, the present invention performs a resource request and transmission of information about the received ranging codes simultaneously, thereby enabling efficient ranging.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A ranging method of an RS (relay station) in a mobile communication system comprising a BS (base station), the RS, and one or more MSs (mobile stations), the ranging method comprising:
checking a status of each of a plurality of ranging codes received from the one or more MSs;
generating a message for a request of a CDMA (Code Division Multiple Access) allocation information element together with a bandwidth when the status of some of the ranging codes is one of “continue” and “abort”; and
transmitting the generated message to the BS.

2. The ranging method of claim 1, further comprising being allocated a bandwidth for transmission of a ranging response message from the BS in response to the message for the request of the CDMA allocation information element together with the bandwidth, and receiving an uplink map comprising the CDMA allocation information element.

3. The ranging method of claim 1, wherein the generating of the message comprises generating a message for a request of the CDMA allocation information element when the status of all of the ranging codes is “success”.

4. The ranging method of claim 1, wherein the generating of the message comprises generating a message for a request of the bandwidth when the status of all of the ranging codes is one of “continue” and “abort”.

5. An RS performing ranging, the RS comprising:
a ranging code check unit checking a status of each of a plurality of ranging codes received from one or more MSs;
a message generation unit generating a message for a request of a CDMA allocation information element together with a bandwidth when the status of some of the ranging codes is one of “continue” and “abort”; and
a message transmitting unit transmitting the generated message to a BS.

6. The RS of claim 5, further comprising a message receiving unit being allocated a bandwidth for transmission of a ranging response message from the BS in response to the message for the request of the CDMA allocation information element together with the bandwidth, and receiving an uplink map comprising the CDMA allocation information element.

7. The RS of claim 5, wherein the message generation unit generates a message for a request of the CDMA allocation information element when the status of all of the ranging codes is “success”.

8. The RS of claim 5, wherein the message generation unit generates a message for a request of the bandwidth when the status of all of the ranging codes is one of “continue” and “abort”.
